(19) United States
(12) Patent Application Publication
(10) Pub. No.: US 2024/0341355 A1
(43) Pub. Date: Oct. 17, 2024

(54) AN AEROSOL-GENERATING DEVICE COMPRISING A CLOSURE MEMBER

(71) Applicant: Philip Morris Products S.A., Neuchatel (CH)

(72) Inventors: Michele CATTONI, Tramelan (CH); Mathias Torsten Rickard TINGSTRÖM, Morges (CH); Ezequiel VALDEZ ROJAS, Pully (CH); Valerio OLIANA, Pully (CH)

(73) Assignee: Philip Morris Products S.A., Neuchatel (CH)

(21) Appl. No.: 18/579,695

(22) PCT Filed: Jul. 20, 2022
(86) PCT No.: PCT/EP2022/070423

§ 371 Date: Jan. 16, 2024

(30) Foreign Application Priority Data
Jul. 21, 2021 (EP) 21186990.4

(51) Int. Cl. A24F 40/40; A24F 40/20; A24F 40/50; A24F 40/95

(52) U.S. Cl. CPC A24F 40/40; A24F 40/50; A24F 40/95; A24F 40/20

(57) ABSTRACT

An aerosol-generating device is provided, including: a housing including a first housing portion defining a cavity configured to receive an aerosol-forming substrate and an opening at an end of the cavity, and a second housing portion configured for removable attachment to the first housing portion; and a closure member connected to the second housing portion, the closure member being moveable between a closed position in which the closure member at least partially covers the opening when the second housing portion is attached to the first housing portion and an open position in which the opening is uncovered when the second housing portion is attached to the first housing portion.

The present invention relates to an aerosol-generating device comprising a first housing portion, a second housing portion, and a closure member.

One type of aerosol-generating system is an electrically operated smoking system. Known handheld electrically operated smoking systems typically comprise an aerosol-generating device comprising a battery, control electronics and an electric heater for heating an aerosol-generating article designed specifically for use with the aerosol-generating device. In some examples, the aerosol-generating article comprises an aerosol-forming substrate, such as a tobacco rod or a tobacco plug, and the heater contained within the aerosol-generating device is inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

In known electrically operated smoking systems the aerosol-generating article may be received within a cavity in the aerosol-generating device. Some aerosol-generating devices may comprise a slidable cover or other closure member that a user may position over an opening of the cavity when the aerosol-generating device is not being used. However, some known devices may comprise two housing portions that are detachable from each other. Such examples present a problem of providing a closure member that may function as required when the two housing portions are connected to each other but does not interfere with the detachment of one housing portion from the other housing portion.

It would be desirable to provide an aerosol-generating device comprising a closure member that facilitates simple and reliable operation of the closure member and facilitates first and second housing portions being detachable from each other.

According to the present disclosure there is provided an aerosol-generating device comprising a housing. The housing may comprise a first housing portion. The first housing portion may define a cavity for receiving an aerosol-forming substrate. The first housing portion may define an opening at an end of the cavity. The housing may comprise a second housing portion. The second housing portion may be configured for removable attachment to the first housing portion. The aerosol-generating device may comprise a closure member. The closure member may be connected to the second housing portion. The closure member may be moveable into a closed position in which the second closure member at least partially covers the opening. The closure member may be moveable into the closed position when the second housing portion is attached to the first housing portion. The closure member may be moveable into an open position in which the opening is uncovered. The closure member may be moveable into the open position when the second housing portion is attached to the first housing portion. The closure member may be moveable between the closed position and the open position.

According to the present disclosure there is also provided an aerosol-generating device comprising a housing, the housing comprising a first housing portion defining a cavity for receiving an aerosol-forming substrate and an opening at an end of the cavity. The housing also comprises a second housing portion, wherein the second housing portion is configured for removable attachment to the first housing portion. The aerosol-generating device also comprises a closure member connected to the second housing portion. The closure member is moveable between a closed position in which the closure member at least partially covers the opening when the second housing portion is attached to the first housing portion and an open position in which the opening is uncovered when the second housing portion is attached to the first housing portion.

Advantageously, providing the opening on the first housing portion and the closure member connected to the second housing portion may facilitate detachment of the second housing portion from the first housing portion. For example, moving the closure member into the open position in which the opening is uncovered may facilitate detachment of the second housing portion from the first housing portion.

The closure member may comprise a fixed portion connected to the second housing portion and a moveable portion connected to the fixed portion, wherein the moveable portion is moveable with respect to the fixed portion between the closed position and the open position.

Advantageously, providing the closure member with a fixed portion may facilitate connection of the closure member to the second housing portion.

At least part of the fixed portion may be connected to the second housing portion by an interference fit.

At least part of the fixed portion may be connected to the second housing portion by an adhesive.

The housing may comprise a first end and a second end opposite the first end, wherein the opening is positioned at the first end of the housing. The first end of the housing may comprise a first wall when the second housing portion is attached to the first housing portion. The opening may extend through a first part of the first wall. The first part of the first wall may be formed by the first housing portion. The fixed portion of the closure member may be connected to a second part of the first wall. The second part of the first wall may be formed by the second housing portion.

The moveable portion may be rotatable with respect to the fixed portion. Advantageously, a rotatable moveable portion may facilitate ease of use of the closure member by a user. For example, when a user is holding the aerosol-generating device with a hand, a rotational movement of the thumb of the same hand may be a more natural movement than a sliding motion, for example. Therefore, advantageously, a rotatable moveable portion facilitates holding the aerosol-generating device and operating the closure member with a single hand. Advantageously, holding the aerosol-generating device and operating the closure member with a single hand facilitates insertion of an aerosol-generating article into the cavity. For example, a user may hold the aerosol-generating device in one hand and operate the closure member with the same hand, and at the same time use the remaining hand to hold an aerosol-generating article and insert the aerosol-generating article into the cavity.

The closure member may comprise a hinge line between the fixed portion and the movable portion, wherein the moveable portion is rotatable about the hinge line with respect to the fixed portion.

Advantageously, a closure member comprising a hinge line between the fixed portion and the moveable portion may be cost effective to manufacture. Advantageously, a closure member comprising a hinge line between the fixed portion and the moveable portion may facilitate ease of use by a user.

The closure member may be formed from a substrate material, wherein the hinge line is formed by a line of weakness in the substrate material. The line of weakness may comprise at least one of a score line, a fold line, and a line of ablation.

The closure member may be formed from a flexible material, wherein the moveable portion is continuous with the fixed portion.

The closure member may be formed from a plastic.

The closure member may be formed from an elastomer. The closure member may be formed from a silicone elastomer. The closure member may be formed from a thermoplastic elastomer.

The moveable portion may be arranged to overlie the fixed portion when the moveable portion is in the open position. Advantageously, arranging the moveable portion to overlie the fixed portion in the open position may reduce or prevent interference of the moveable portion with the use of the aerosol-generating device. Advantageously, arranging the moveable portion to overlie the fixed portion in the open position may reduce the risk of damage to the moveable portion when the second housing portion is detached from the first housing portion. In embodiments in which the moveable portion is rotatable with respect to the fixed portion, the closure member may be foldable into the closed position from the open position. For example, in embodiments in which the closure member comprises a hinge line, the closure member may be foldable about the hinge line.

The aerosol-generating device may comprise a latching element arranged to retain the closure member in the open position. Advantageously, the latching element may reduce the risk of the closure member being accidently moved from the open position.

The latching element may comprise a part of the second housing portion arranged to engage a part of the closure member when the closure member is in the open position. The latching element may comprise a part of the second housing portion arranged to engage a part of the closure member by an interference fit when the closure member is in the open position.

The latching element may be configured to engage the moveable portion of the closure member when the moveable portion is in the open position.

The latching element may comprise at least one magnetic element. As used herein, the term “magnetic element” is used to refer to magnets and magnetisable materials, such as ferromagnetic materials. The at least one magnetic element may comprise a latching magnetic element positioned on the fixed portion of the closure member and a second magnetic element positioned on the moveable portion of the closure member. The latching magnetic element may comprise a magnet and the second magnetic element may comprise a magnetisable material. The latching magnetic element may comprise a magnetisable material and the second magnetic element may comprise a magnet. The latching magnetic element and the second magnetic element may each comprise a magnet.

The closure member may be formed from a substrate material. Each magnetic element may be at least partially contained within the substrate material. Each magnetic element may be entirely contained within the substrate material. The substrate material may comprise a flexible material, as described herein.

The aerosol-generating device may comprise a retaining element arranged to retain the closure member in the closed position.

The retaining element may comprise a part of the first housing portion arranged to engage a part of the closure member when the closure member is in the closed position. The retaining element may comprise a part of the first housing portion arranged to engage a part of the closure member by an interference fit when the closure member is in the closed position.

The retaining element may be configured to engage the moveable portion of the closure member when the moveable portion is in the closed position.

The retaining element may comprise at least one magnetic element. The at least one magnetic element may comprise a retaining magnetic element positioned on the first housing portion and a second magnetic element positioned on the moveable portion of the closure member. The retaining magnetic element may comprise a magnet and the second magnetic element may comprise a magnetisable material. The retaining magnetic element may comprise a magnetisable material and the second magnetic element may comprise a magnet. The retaining magnetic element and the second magnetic element may each comprise a magnet.

The retaining magnetic element may be at least partially contained within the first housing portion. The retaining magnetic element may be entirely contained within the first housing portion.

The closure member may be formed from a substrate material. The second magnetic element may be at least partially contained within the substrate material. The second element may be entirely contained within the substrate material. The substrate material may comprise a flexible material, as described herein.

The retaining element may comprise a protrusion on the closure member, wherein the protrusion is arranged to be received in the opening of the first housing portion when the closure member is in the closed position. Preferably, the protrusion extends from the moveable portion of the closure member.

Advantageously, the protrusion may facilitate a seal between the closure member and the opening of the first housing portion when the closure member is in the closed position. Preferably, the protrusion is sized to be retained within the opening by an interference fit.

The protrusion may have an annular shape. Advantageously, an annular shape may facilitate deformation of the protrusion when the protrusion is received within the opening of the first housing portion. Advantageously, deformation of the protrusion may facilitate a seal between the protrusion and the opening of the first housing portion.

At least one of the first housing portion and the second housing portion may define a recess, wherein at least part of the closure member is positioned within the recess. Advantageously, positioning at least part of the closure member within a recess may reduce the risk of damage to the closure member.

At least part of the opening may be positioned within the recess. Advantageously, positioning at least part of the opening within the recess may facilitate positioning of at least part of the closure member within the recess when the closure member is in the closed position.

The housing may comprise a first end and a second end opposite the first end, wherein the opening is positioned at the first end of the housing, wherein the housing comprises a rim extending at least partially around a perimeter of the first end of the housing, and wherein the recess is defined by the rim.

Each of the first housing portion and the second housing portion may define part of the rim.

The housing may comprise a gap in the rim at the perimeter of the first end of the housing. Advantageously, the gap may facilitate a user grasping a part of the closure member to move the closure member from the closed position to the open position.

Preferably, the gap is positioned on the first housing portion.

Part of the closure member may be arranged to be received within the gap when the closure member is in the closed position.

Preferably, part of the movable portion of the closure member is arranged to be received within the gap when the moveable portion is in the closed position.

Preferably, the fixed portion of the closure member is positioned within the recess.

The closure member may be arranged to overlie the second housing portion when the closure member is in the open position.

Advantageously, arranging the closure member to overlie the second housing portion in the open position may reduce or prevent interference of the closure member with the use of the aerosol-generating device. Advantageously, arranging the closure member to overlie the second housing portion in the open position may reduce the risk of damage to the closure member when the second housing portion is detached from the first housing portion.

The first housing portion may comprise a first end, a second end opposite the first end, and at least one sidewall extending between the first end and the second end, wherein the opening is positioned at the first end of the first housing portion, and wherein the second housing portion is configured for removable attachment to the at least one sidewall.

Each of the first housing portion and the second housing portion may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

Preferably, the aerosol-generating device comprises an electric heater positioned within the first housing portion, a power supply positioned within the second housing portion, and a controller positioned within the first housing portion or the second housing portion, wherein the controller is configured to control a supply of power from the power supply to the electric heater when the second housing portion is attached to the first housing portion.

Advantageously, providing the power supply in the second housing portion may facilitate the use of different power supplies with the first housing portion. For example, the user may exchange the second housing portion containing a discharged power supply for a further housing portion containing a full charged power supply. In another example, the user may exchange the second housing portion containing a first power supply having a first charge storage capacity for a further housing portion containing a second power supply having a different, second charge storage capacity.

The electric heater may be positioned outside the cavity.

The electric heater may be positioned within the cavity.

The electric heater may be arranged to extend around an outer surface of an aerosol-generating article received within the cavity.

The electric heater may be coil-shaped. The electric heater may be configured to heat a fluid transport structure. The aerosol-generating device may comprise a fluid transport structure, wherein the electric heater is arranged to heat the fluid transport structure. The fluid transport structure may comprise a wick. The electric heater may be coil-shaped, wherein the electric heater is coiled around the fluid transport structure.

The electric heater may extend into the cavity. The electric heater may be arranged to be received within an aerosol-generating article when the aerosol-generating article is inserted into the cavity. The electric heater may be an elongate electric heater. The electric heater may be blade-shaped. The electric heater may be pin-shaped. The electric heater may be cone-shaped.

The electric heater may comprise an inductive heating element. During use, the inductive heating element inductively heats at least one susceptor material to heat an aerosol-generating article received within the cavity. The at least one susceptor material may form part of the aerosol-generating device. The at least one susceptor material may form part of the aerosol-generating article. The inductive heating element may comprise at least one inductor coil extending around at least a portion of the cavity so that, when an aerosol-generating article is inserted into the cavity, at least a portion of the aerosol-generating article is received within the at least one inductor coil.

The electric heater may comprise a resistive heating element. During use, an electrical current is supplied to the resistive heating element to generate heat by resistive heating.

Suitable materials for forming the resistive heating element include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys.

In some embodiments, the resistive heating element comprises one or more stamped portions of electrically resistive material, such as stainless steel. Alternatively, the resistive heating element may comprise a heating wire or filament, for example a Ni—Cr (Nickel-Chromium), platinum, tungsten or alloy wire.

The electric heater may comprise an electrically insulating substrate, wherein the resistive heating element is provided on the electrically insulating substrate. The electrically insulating substrate may be a ceramic material such as Zirconia or Alumina. Preferably, the electrically insulating substrate has a thermal conductivity of less than or equal to about 2 Watts per metre Kelvin.

Preferably, the controller is arranged to supply power from the power supply to the electric heater according to a predetermined heating cycle when the aerosol-generating device is used to heat an aerosol-generating article received within the cavity.

In embodiments in which the electric heater comprises a resistive heating element, the controller may be arranged to supply power from the power supply to the resistive heating element according to a predetermined pyrolysis cycle to clean the electric heater when there is not an aerosol-generating article received within the cavity. The pyrolysis cycle may clean the electric heater by pyrolysis of residue remaining on the electric heater after use of the aerosol-generating device to heat one or more aerosol-generating articles. Typically, the maximum temperature to which the electric heater is heated during a pyrolysis cycle is higher than the maximum temperature to which the electric heater is heated during a heating cycle to heat an aerosol-generating article. Typically, the total duration of a pyrolysis cycle is shorter than the total duration of a heating cycle.

The power supply may be a DC voltage source. In preferred embodiments, the power supply is a battery. For example, the power supply may be a nickel-metal hydride battery, a nickel cadmium battery, or a lithium based battery, for example a lithium-cobalt, a lithium-iron-phosphate or a lithium-polymer battery. The power supply may alternatively be another form of charge storage device such as a capacitor. The power supply may require recharging and may have a capacity that allows for the storage of enough energy for use of the aerosol-generating device with one or more aerosol-generating articles.

Preferably, the aerosol-generating device comprises at least one air inlet. Preferably, the at least one air inlet is in fluid communication with the cavity.

The aerosol-generating device may comprise a sensor to detect air flow indicative of a user taking a puff. The air flow sensor may be an electro-mechanical device. The air flow sensor may be any of: a mechanical device, an optical device, an opto-mechanical device and a micro electro-mechanical systems (MEMS) based sensor. The aerosol-generating device may comprise a manually operable switch for a user to initiate a puff.

The aerosol-generating device may comprise a temperature sensor. The temperature sensor may detect the temperature of the electric heater or the temperature of an aerosol-generating article received within the cavity. The temperature sensor may be a thermistor. The temperature sensor may comprise a circuit configured to measure the resistivity of the electric heater and derive a temperature of the electric heater by comparing the measured resistivity to a calibrated curve of resistivity against temperature.

Advantageously, deriving the temperature of the electric heater may facilitate control of the temperature to which the electric heater is heated during use. The controller may be configured to adjust the supply of power to the electric heater in response to a change in the measured resistivity of the electric heater.

Advantageously, deriving the temperature of the electric heater may facilitate puff detection. For example, a measured drop in the temperature of the electric heater may correspond to a user puffing or drawing on the aerosol-generating device.

Preferably, the aerosol-generating device comprises an indicator for indicating when the electric heater is activated. The indicator may comprise a light, activated when the electric heater is activated.

The aerosol-generating device may comprise at least one of an external plug or socket and at least one external electrical contact allowing the aerosol-generating device to be connected to another electrical device. For example, the aerosol-generating device may comprise a USB plug or a USB socket to allow connection of the aerosol-generating device to another USB enabled device. The USB plug or socket may allow connection of the aerosol-generating device to a USB charging device to charge a rechargeable power supply within the aerosol-generating device. The USB plug or socket may support the transfer of data to or from, or both to and from, the aerosol-generating device. The aerosol-generating device may be connectable to a computer to transfer data to the aerosol-generating device, such as new heating profiles for new aerosol-generating articles.

Preferably, the external plug, socket, or electrical contact is positioned on the second housing portion.

In those embodiments in which the aerosol-generating device comprises a USB plug or socket, the aerosol-generating device may further comprise a removable cover that covers the USB plug or socket when not in use. In embodiments in which the USB plug or socket is a USB plug, the USB plug may additionally or alternatively be selectively retractable within the device.

According to the present disclosure there is also provided an aerosol-generating system comprising an aerosol-generating device as described herein and an aerosol-generating article comprising an aerosol-forming substrate.

As used herein, the term “aerosol-generating article” refers to an article comprising an aerosol-forming substrate that, when heated, releases volatile compounds that can form an aerosol.

The aerosol-forming substrate may comprise a plug of tobacco. The tobacco plug may comprise one or more of: powder, granules, pellets, shreds, spaghettis, strips or sheets containing one or more of: tobacco leaf, fragments of tobacco ribs, reconstituted tobacco, homogenised tobacco, extruded tobacco and expanded tobacco. Optionally, the tobacco plug may contain additional tobacco or non-tobacco volatile flavour compounds, to be released upon heating of the tobacco plug. Optionally, the tobacco plug may also contain capsules that, for example, include the additional tobacco or non-tobacco volatile flavour compounds. Such capsules may melt during heating of the tobacco plug. Alternatively, or in addition, such capsules may be crushed prior to, during, or after heating of the tobacco plug.

The aerosol-generating article may comprise a mouthpiece positioned downstream of the tobacco plug. The mouthpiece may be located at a downstream end of the aerosol-generating article. The mouthpiece may comprise a cellulose acetate filter plug.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device comprising:

a housing comprising:
a first housing portion defining a cavity for receiving an aerosol-forming substrate and an opening at an end of the cavity; and
a second housing portion, wherein the second housing portion is configured for removable attachment to the first housing portion; and

a closure member connected to the second housing portion, wherein the closure member is moveable between a closed position in which the closure member at least partially covers the opening when the second housing portion is attached to the first housing portion and an open position in which the opening is uncovered when the second housing portion is attached to the first housing portion.

Example Ex2: An aerosol-generating device according to Example Ex1, wherein the closure member comprises a fixed portion connected to the second housing portion and a moveable portion connected to the fixed portion, wherein the moveable portion is moveable with respect to the fixed portion between the closed position and the open position.

Example Ex3: An aerosol-generating device according to Example Ex2, wherein the moveable portion is rotatable with respect to the fixed portion.

Example Ex4: An aerosol-generating device according to Example Ex3, wherein the closure member comprises a hinge line between the fixed portion and the movable portion, and wherein the moveable portion is rotatable about the hinge line with respect to the fixed portion.

Example Ex5: An aerosol-generating device according to Example Ex4, wherein the closure member is formed from a substrate material, and wherein the hinge line is formed by a line of weakness in the substrate material.

Example Ex6: An aerosol-generating device according to Example Ex2 or Ex3, wherein the closure member is formed from a flexible material and wherein the moveable portion is continuous with the fixed portion.

Example Ex7: An aerosol-generating device according to any of Examples Ex2 to Ex6, wherein the moveable portion is arranged to overlie the fixed portion when the moveable portion is in the open position.

Example Ex8: An aerosol-generating device according to any preceding Example, further comprising a latching element arranged to retain the closure member in the open position.

Example Ex9: An aerosol-generating device according to Example Ex8, wherein the latching element comprises a part of the second housing portion arranged to engage a part of the closure member when the closure member is in the open position.

Example Ex10: An aerosol-generating device according to Example Ex8 or Ex9 in combination with any of Examples Ex2 to Ex6, wherein the latching element is configured to engage the moveable portion of the closure member when the moveable portion is in the open position.

Example Ex11: An aerosol-generating device according to Example Ex8, wherein the latching element comprises at least one magnetic element.

Example Ex12: An aerosol-generating device according to Example Ex11 in combination with any of Examples Ex2 to Ex7, wherein the at least one magnetic element comprises a latching magnetic element positioned on the fixed portion of the closure member and a second magnetic element positioned on the moveable portion of the closure member.

Example Ex13: An aerosol-generating device according to any preceding Example, further comprising a retaining element arranged to retain the closure member in the closed position.

Example Ex14: An aerosol-generating device according to Example Ex13, wherein the retaining element comprises a part of the first housing portion arranged to engage a part of the closure member when the closure member is in the closed position.

Example Ex15: An aerosol-generating device according to Example Ex13 or Ex14 in combination with any of Examples Ex2 to Ex7, wherein the retaining element is configured to engage the moveable portion of the closure member when the moveable portion is in the closed position.

Example Ex16: An aerosol-generating device according to Example Ex15, wherein the retaining element comprises at least one magnetic element.

Example Ex17: An aerosol-generating device according to Example Ex16 in combination with any of Examples Ex2 to Ex7, wherein the at least one magnetic element comprises a retaining magnetic element positioned on the first housing portion and a second magnetic element positioned on the moveable portion of the closure member.

Example Ex18: An aerosol-generating device according to Example Ex13, wherein the retaining element comprises a protrusion on the closure member, and wherein the protrusion is arranged to be received in the opening of the first housing portion when the closure member is in the closed position.

Example Ex19: An aerosol-generating device according to Example Ex18, wherein the protrusion is sized to be retained within the opening by an interference fit.

Example Ex20: An aerosol-generating device according to Example Ex18 or Ex19, wherein the protrusion has an annular shape.

Example Ex21: An aerosol-generating device according to any of Examples Ex18 to Ex20 in combination with any of Examples Ex2 to Ex7, wherein the protrusion extends from the moveable portion of the closure member.

Example Ex22: An aerosol-generating device according to any preceding Example, wherein at least one of the first housing portion and the second housing portion defines a recess, and wherein at least part of the closure member is positioned within the recess.

Example Ex23: An aerosol-generating device according to Example Ex22, wherein at least part of the opening is positioned within the recess.

Example Ex24: An aerosol-generating device according to Example Ex22 or Ex23, wherein the housing comprises a first end and a second end opposite the first end, wherein the opening is positioned at the first end of the housing, wherein the housing comprises a rim extending at least partially around a perimeter of the first end of the housing, and wherein the recess is defined by the rim.

Example Ex25: An aerosol-generating device according to Example Ex24, wherein each of the first housing portion and the second housing portion defines part of the rim.

Example Ex26: An aerosol-generating device according to Example Ex24 or Ex25, wherein the housing comprises a gap in the rim at the perimeter of the first end of the housing.

Example Ex27: An aerosol-generating device according to Example Ex26, wherein the gap is positioned on the first housing portion.

Example Ex28: An aerosol-generating device according to Example Ex26 or Ex27, wherein part of the closure member is arranged to be received within the gap when the closure member is in the closed position.

Example Ex29: An aerosol-generating device according to Example Ex28 in combination with any of Examples Ex2 to Ex7, wherein part of the movable portion of the closure member is arranged to be received within the gap when the moveable portion is in the closed position.

Example Ex30: An aerosol-generating device according to any of Examples Ex22 to Ex29 in combination with any of Examples Ex2 to Ex7, wherein the fixed portion of the closure member is positioned within the recess.

Example Ex31: An aerosol-generating device according to any preceding Example, wherein the closure member is formed from a plastic.

Example Ex32: An aerosol-generating device according to any of Examples Ex1 to Ex30, wherein the closure member is formed from an elastomer.

Example Ex33: An aerosol-generating device according to Example Ex32, wherein the closure member is formed from a silicone elastomer.

Example Ex34: An aerosol-generating device according to any of Examples Ex1 to Ex30, wherein the closure member is formed from a thermoplastic elastomer.

Example Ex35: An aerosol-generating device according to any preceding Example, wherein the closure member is arranged to overlie the second housing portion when the closure member is in the open position.

Example Ex36: An aerosol-generating device according to any preceding Example, wherein the first housing portion comprises a first end, a second end opposite the first end, and at least one sidewall extending between the first end and the second end, wherein the opening is positioned at the first end of the first housing portion, and wherein the second housing portion is configured for removable attachment to the at least one sidewall.

Example Ex37: An aerosol-generating device according to any preceding Example, further comprising:

an electric heater positioned within the first housing portion;

a power supply positioned within the second housing portion; and

a controller positioned within the first housing portion or the second housing portion, wherein the controller is configured to control a supply of power from the power supply to the electric heater when the second housing portion is attached to the first housing portion.

The invention will now be further described, by way of example only, with reference to the accompanying drawings in which:

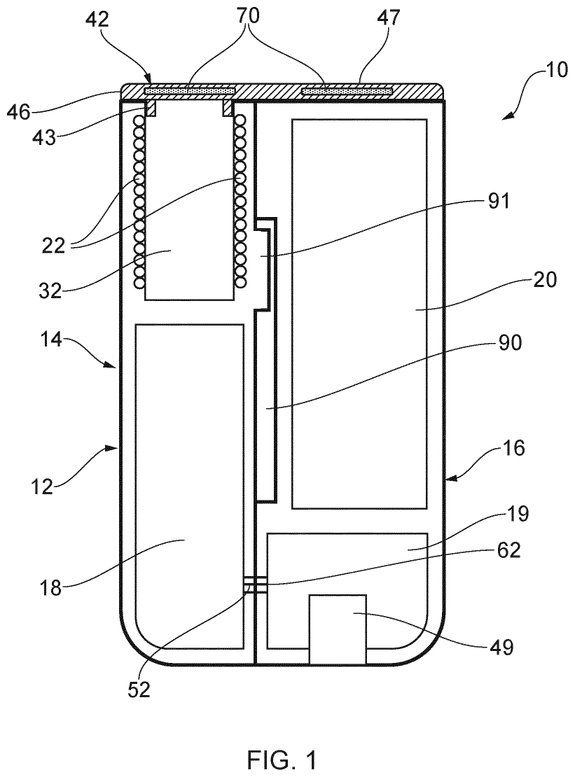

FIG. 1 is a cross-sectional view of an aerosol-generating device according to an embodiment of the present invention with the closure member in the closed position.

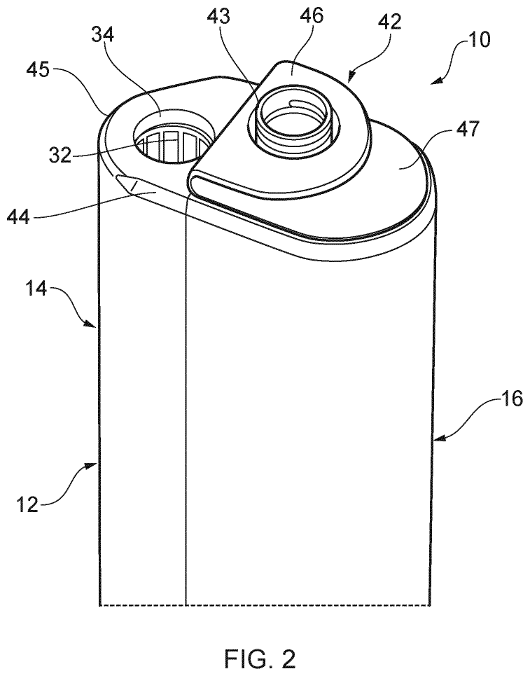

FIG. 2 is a perspective view of the aerosol-generating device of FIG. 1 with the closure member in the open position.

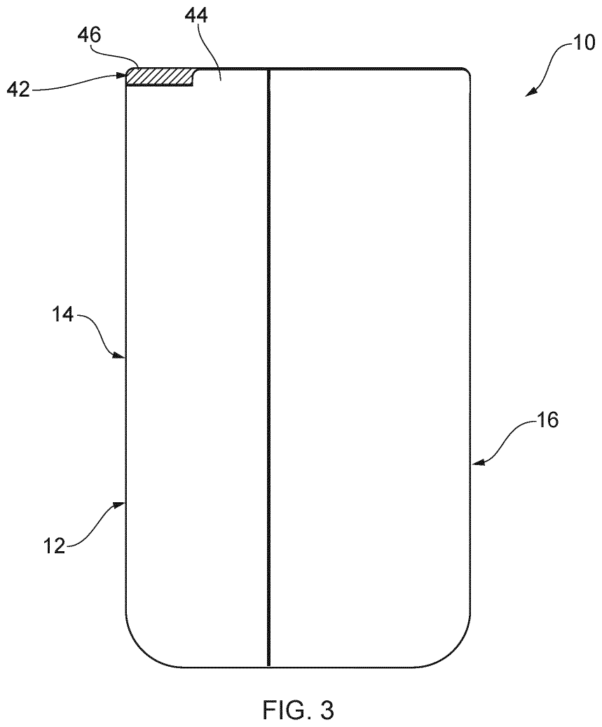

FIG. 3 is a front view of the aerosol-generating device of FIG. 1 with the closure member in the closed position.

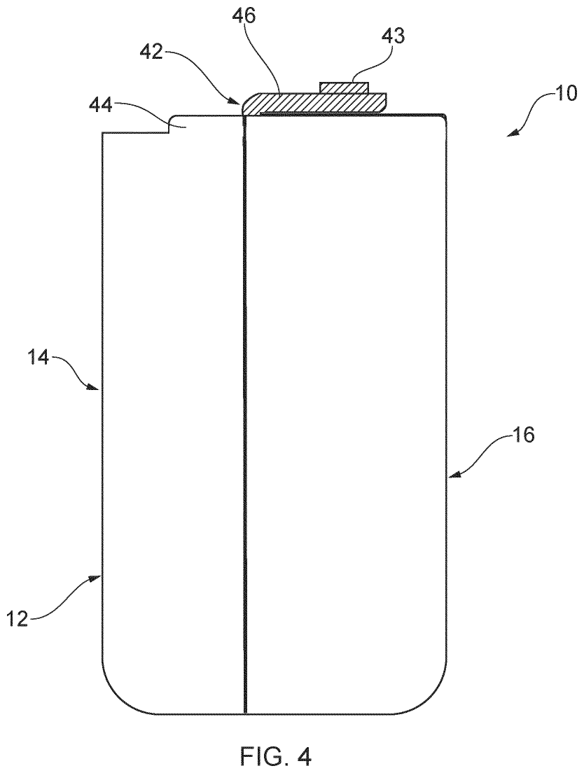

FIG. 4 is a front view of the aerosol-generating device of FIG. 1 with the closure member in the open position.

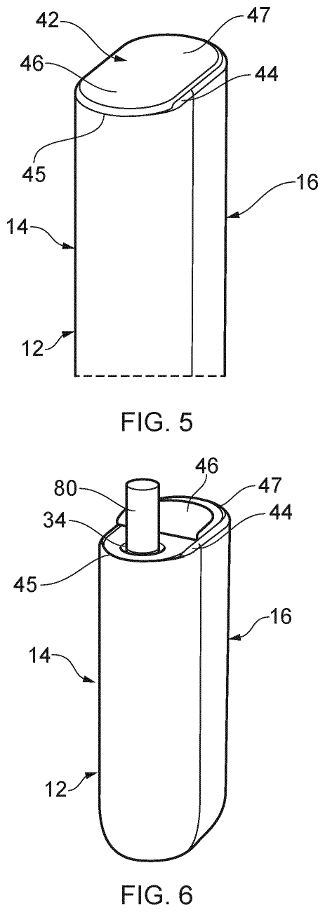

FIG. 5 is a perspective view of the aerosol-generating device of FIG. 1 with the closure member in the closed position.

FIG. 6 is a perspective view of the aerosol-generating device of FIG. 1 with the closure member in the open position and an aerosol-generating article received in the cavity of the first housing portion.

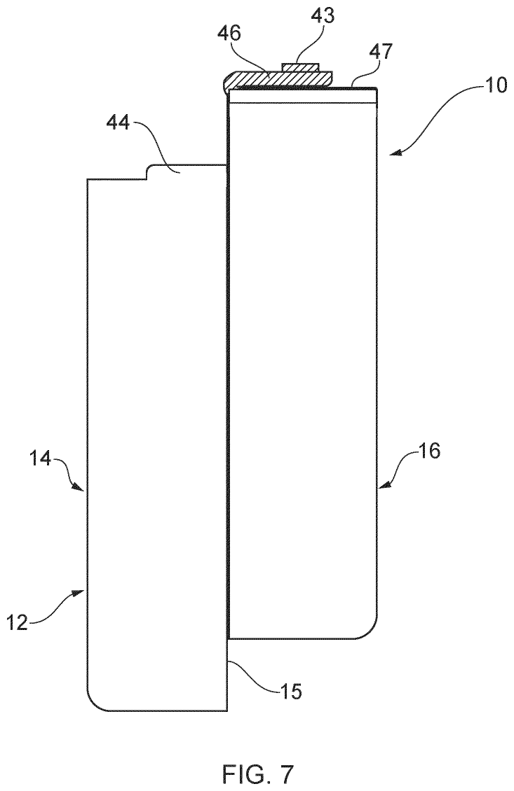

FIG. 7 is a front view of the aerosol-generating device of FIG. 1 with the closure member in the open position and the second housing portion moved relative to the first housing portion.

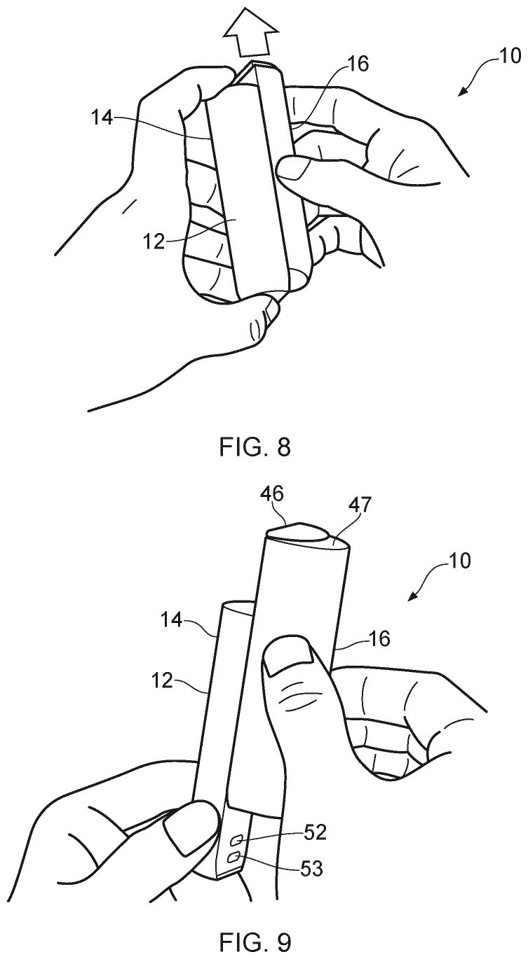

FIGS. 8 and 9 are perspective views of the aerosol-generating device of FIG. 1 showing the second housing portion sliding relative to the first housing portion.

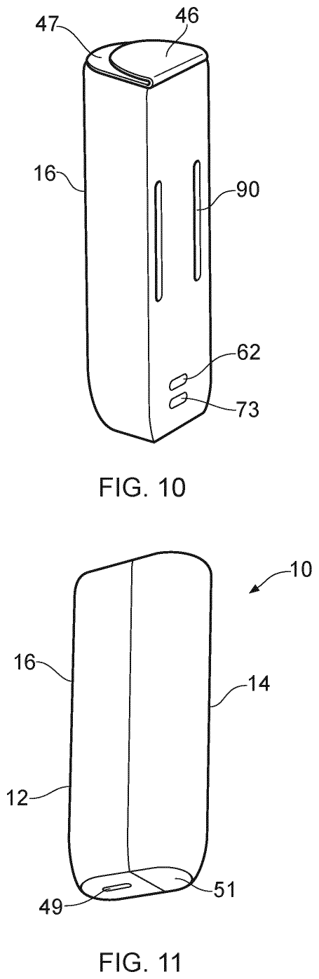

FIG. 10 is a perspective view of the second housing portion of the aerosol-generating device of FIG. 1.

FIG. 11 is a perspective view of the aerosol-generating device of FIG. 1 showing the charging electrical contact.

FIGS. 1 to 11 show an aerosol-generating device 10 according to an embodiment of the present invention. The aerosol-generating device 10 comprises a housing 12 comprising a first housing portion 14 and second housing portion 16. The second housing portion 16 is configured for removable attachment to the first housing portion 14. A first electrical contact 52 is positioned on the first housing portion 14 and a second electrical contact 62 is positioned on the second housing portion 16. The first electrical contact 52 and the second electrical contact 62 are arranged to contact each other when the second housing portion 16 is attached to the first housing portion 14.

The aerosol-generating device 10 also comprises a charging circuit 19 and a power supply 20 positioned within the second housing portion 16. The power supply 20 is an electrical power supply comprising a rechargeable battery. A charging electrical contact 49, which is in the form of a USB-C connector, is included at an end of the second housing portion 16 and is configured to receive a supply of power from an external device. The charging circuit 19 is configured to control the supply of power received from an external device for recharging the power supply 20.

The first housing portion 14 defines a cavity 32 for receiving an aerosol-generating article 80 and an opening 34 positioned at an end of the cavity 32. When an aerosol-generating article 80 is received within the cavity 32, the aerosol-generating article 80 and the aerosol-generating device 10 together form an aerosol-generating system.

The aerosol-generating device 10 further comprises an electric heater 22 and controller 18 positioned within the first housing portion 14. The electric heater 22 comprises an inductor coil wound around the cavity 32. The controller 18 is configured to control a supply of power from the power supply 20 to the electric heater 22 via the first electrical contact 52 and the second electrical contact 62 when the second housing portion 16 is attached to the first housing portion 14. During use, the power supplied to the inductor coil of the electric heater 22 generates a varying magnetic field that inductively heats a susceptor in the aerosol-generating article 80 received within the cavity 32 to generate an aerosol.

The aerosol-generating device 10 also comprises a closure member 42 positioned at a first end of the housing. The closure member 42 comprises a fixed portion 47 connected to the second housing portion 16 and a moveable portion 46 formed integrally with the fixed portion 47. The closure member 42 is formed from a flexible material so that the closure member 42 may be folded back on itself. In other words, the moveable portion 46 may be rotated relative to the fixed portion 47. The moveable portion 46 is rotatable with respect to the fixed portion 47 between a closed position in which the moveable portion 46 covers the opening 34 and an open position in which the moveable portion 46 does not cover the opening 34. When the moveable portion 46 is in an open position, the aerosol-generating article 80 can be received within the cavity 32. The closed position is illustrated in FIG. 1 and the open position is illustrated in FIG. 2.

A pair of magnets 70 is contained within the closure member 42 such that one magnet is positioned inside the moveable portion 46 and the other magnet is positioned inside the fixed portion 47. The magnets 70 are arranged to retain the moveable portion 46 against the fixed portion 47 when the moveable portion 46 is in the open position.

The closure member 42 also comprises a protrusion 43 extending from the moveable portion 46. The protrusion 43 is formed integrally with the moveable portion 46 and has an annular shape. The protrusion 43 is arranged such that, when the moveable portion 46 is in a closed position, the protrusion 43 is received within the opening 34 and engages the opening 34 by an interference fit. Advantageously, when the moveable portion 46 is in the closed position, the protrusion seals the opening 34 and retains the moveable portion 46 in the closed position.

The housing 12 comprises a rim 44 extending around part of the perimeter of the first end of the housing 12. The rim 44 forms a recess in which the closure member 42 is positioned. Advantageously, the rim 44 protects the fixed portion 47 and protects the moveable portion 46 when the moveable portion 46 is in the closed position. A gap 45 in the rim 44 on the first housing portion allows an edge of the moveable portion 46 to be gripped when moving the moveable portion 46 from the closed position to the open position.

The second housing portion 16 comprises an interface for receiving at least a portion of the first housing portion 14 to retain the second housing portion 16 in releasable attachment with the first housing portion 14. The interface comprises a slot 90 configured to slidably receive at least a part of the first housing portion 14. The slot 90 facilitates the sliding movement of the second housing portion 16 relative to the first housing portion 14. A second electrical contact 62 on the second housing portion 16 engages with the first electrical contact 52 on the first housing portion 14 when the second housing portion 16 is attached to the first housing portion 14.

As shown in FIGS. 7 to 9, the second housing portion 16 is slidably detachable from the first housing portion 14. To detach the second housing portion 16 from the first housing portion 14, a release button 51 at a second end of the first housing portion 14 is pressed to disengage a latching element from the second housing portion 16. Pressing the release button 51 allows the second housing portion 16 to slide relative to the first housing portion 14 until the second housing portion 16 is fully detached from the first housing portion 14. To attach the second housing portion 16 to the first housing portion 14, the sliding operation is reversed until the latching element engages the second housing portion 16. To facilitate alignment of the second housing portion 16 with the first housing portion 14, protrusions 91 on the first housing portion 14 are arranged to slide within guide slots 90 on the second housing portion 16.

As shown in FIG. 9, detaching the second housing portion 16 from the first housing portion 14 reveals a device reset button 53 provided on the first housing portion 14. As shown in FIG. 10, detaching the second housing portion 16 from the first housing portion 14 reveals an LED charge indicator 73 provided on the second housing portion 16. The LED charge indicator 73 is configured to provide a user with a visual indication of an amount of electrical charge stored within the power supply 20.

1.-15. (canceled)

16. An aerosol-generating device, comprising:
a housing comprising:
a first housing portion defining a cavity configured to receive an aerosol-forming substrate and an opening at an end of the cavity, and
a second housing portion configured for removable attachment to the first housing portion; and
a closure member connected to the second housing portion, wherein the closure member is moveable between a closed position in which the closure member at least partially covers the opening when the second housing portion is attached to the first housing portion and an open position in which the opening is uncovered when the second housing portion is attached to the first housing portion.

17. The aerosol-generating device according to claim 16,
wherein the closure member comprises a fixed portion connected to the second housing portion and a moveable portion connected to the fixed portion, and
wherein the moveable portion is moveable with respect to the fixed portion between the closed position and the open position.

18. The aerosol-generating device according to claim 17, wherein the moveable portion is rotatable with respect to the fixed portion.

19. The aerosol-generating device according to claim 17, wherein the moveable portion is arranged to overlie the fixed portion when the moveable portion is in the open position.

20. The aerosol-generating device according to claim 16, further comprising a latching element arranged to retain the closure member in the open position.

21. The aerosol-generating device according to claim 20, wherein the latching element comprises at least one magnetic element.

22. The aerosol-generating device according to claim 16, further comprising a retaining element arranged to retain the closure member in the closed position.

23. The aerosol-generating device according to claim 22,
wherein the retaining element comprises a protrusion on the closure member, and
wherein the protrusion is arranged to be received in the opening of the first housing portion when the closure member is in the closed position.

24. The aerosol-generating device according to claim 23, wherein the protrusion is sized to be retained within the opening by an interference fit.

25. The aerosol-generating device according to claim 23, wherein the protrusion has an annular shape.

26. The aerosol-generating device according to claim 16,
wherein at least one of the first housing portion and the second housing portion defines a recess, and
wherein at least part of the closure member is positioned within the recess.

27. The aerosol-generating device according to claim 26, wherein at least part of the opening is positioned within the recess.

28. The aerosol-generating device according to claim 26,
wherein the housing comprises a first end and a second end opposite the first end,
wherein the opening is positioned at the first end of the housing,
wherein the housing further comprises a rim extending at least partially around a perimeter of the first end of the housing, and
wherein the recess is defined by the rim.

29. The aerosol-generating device according to claim 28, wherein each of the first housing portion and the second housing portion defines part of the rim.

30. The aerosol-generating device according to claim 28, wherein the housing further comprises a gap in the rim at the perimeter of the first end of the housing.

31. The aerosol-generating device according to claim 30, wherein the gap is positioned on the first housing portion.

32. The aerosol-generating device according to claim 16,
wherein the first housing portion comprises a first end, a second end opposite the first end, and at least one sidewall extending between the first end and the second end,
wherein the opening is positioned at the first end of the first housing portion, and
wherein the second housing portion is configured for removable attachment to the at least one sidewall.

33. The aerosol-generating device according to claim 16, further comprising:
an electric heater positioned within the first housing portion;
a power supply positioned within the second housing portion; and
a controller positioned within the first housing portion or the second housing portion, wherein the controller is configured to control a supply of power from the power supply to the electric heater when the second housing portion is attached to the first housing portion.
